(19) United States
(12) Patent Application Publication
(10) Pub. No.: US 2026/0249187 A1
(43) Pub. Date: Aug. 27, 2026

(54) VIRTUAL SCENE INTERACTION PROCESSING METHOD AND APPARATUS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: Ying DENG, Shenzhen (CN)

(21) Appl. No.: 19/354,681

(22) Filed: Oct. 9, 2025

Related U.S. Application Data
(63) Continuation of application No. PCT/CN2024/116314, filed on Sep. 2, 2024.

(30) Foreign Application Priority Data
Nov. 17, 2023 (CN) 202311540513.7

(51) Int. Cl. A63F 13/57; A63F 13/52; A63F 13/533; A63F 13/58

(52) U.S. Cl. CPC A63F 13/57; A63F 13/52; A63F 13/533; A63F 13/58

(57) ABSTRACT

This application provides a virtual scene interaction processing method performed by an electronic device. The method includes: displaying a virtual scene in a human-computer interaction interface, the virtual scene including a plurality of virtual objects; displaying, in response to a first virtual object being attacked by at least one second virtual object, at least one under-attack prompt control in the virtual scene, a pointing direction of each under-attack prompt control being consistent with an attack direction of a corresponding second virtual object; and controlling, in response to a trigger operation for a target under-attack prompt control, the first virtual object to turn to a target direction, and the target direction being a direction opposite to a pointing direction of the target under-attack prompt control.

### CROSS-REFERENCE TO RELATED APPLICATIONS

This application is a continuation application of PCT Patent Application No. PCT/CN2024/116314, entitled “VIRTUAL SCENE INTERACTION PROCESSING METHOD AND APPARATUS, ELECTRONIC DEVICE, COMPUTER-READABLE STORAGE MEDIUM, AND COMPUTER PROGRAM PRODUCT” filed on Sep. 2, 2024, which claims priority to Chinese Patent Application No. 202311540513.7, entitled “VIRTUAL SCENE INTERACTION PROCESSING METHOD AND APPARATUS, ELECTRONIC DEVICE, COMPUTER-READABLE STORAGE MEDIUM, AND COMPUTER PROGRAM PRODUCT” filed on Nov. 17, 2023, all of which are incorporated by reference in their entirety.

### FIELD OF THE TECHNOLOGY

This application relates to the technical field of computer human-computer interaction, and in particular, to a virtual scene interaction processing method and apparatus, an electronic device, a computer-readable storage medium, and a computer program product.

### BACKGROUND OF THE DISCLOSURE

The display technology based on graphics processing hardware, especially the display technology of virtual scenes, expands the channels for perceiving the environment and acquiring information, which can realize diverse interactions between virtual objects controlled by users or artificial intelligence (AI) according to practical application requirements and has various typical application scenes. For example, in virtual scenes such as games, the real battle process between the virtual objects can be simulated.

Taking a mobile game as an example, in the related art, if a game character controlled by a player is attacked by an enemy (such as a game character controlled by another player), the player needs to manually adjust a screen direction to locate the orientation of an attacker in a game scene and launch a counterattack. Thus, in the solution provided in the related art, the player needs to perform multiple operations to find the enemy and launch the counterattack, resulting in low human-computer interaction efficiency.

### SUMMARY

Embodiments of this application provide a virtual scene interaction processing method and apparatus, an electronic device, a computer-readable storage medium, and a computer program product, which can quickly and efficiently control a virtual object to turn to an attacker, thereby improving the human-computer interaction efficiency in a virtual scene.

Technical solutions in the embodiments of this application are implemented as follows.

An embodiment of this application provides a virtual scene interaction processing method, performed by an electronic device and the method including:
displaying a virtual scene in a human-computer interaction interface, the virtual scene including a plurality of virtual objects;
displaying, in response to a first virtual object being attacked by at least one second virtual object, in the virtual scene at least one under-attack prompt control, a pointing direction of each under-attack prompt control being consistent with an attack direction of a corresponding second virtual object; and
controlling, in response to a trigger operation for a target under-attack prompt control, the first virtual object to turn to a target direction, and the target direction being a direction opposite to a pointing direction of the target under-attack prompt control.

An embodiment of this application provides an electronic device, including:
a memory, configured to store executable instructions; and
a processor, configured to, when executing the executable instructions stored in the memory, implement the virtual scene interaction processing method provided in this embodiment of this application.

An embodiment of this application provides a non-transitory computer-readable storage medium, having computer-executable instructions stored therein, the computer-executable instructions, when executed by a processor of a computer device, causing the computer device to implement the virtual scene interaction processing method provided in this embodiment of this application.

The embodiments of this application have the following beneficial effects:

When a virtual object (i.e., the first virtual object) controlled by a player is attacked by another virtual object (i.e., the second virtual object) in the virtual scene, the under-attack prompt control carrying the attack direction for instructing an attacker (i.e., the second virtual object) is displayed in the virtual scene, and when a trigger operation performed by the player for a selected under-attack prompt control (i.e., the target under-attack prompt control) is received, the first virtual object may be controlled to turn to the direction opposite to the pointing direction of the target under-attack prompt control, i.e., to face a direction of the second virtual object corresponding to the target under-attack prompt control. In this way, compared with the technical solution provided in the related art, the technical solutions provided in the embodiments of this application can quickly and efficiently control the virtual object to turn to the attacker, which facilitates the player to launch a counterattack, thereby improving the human-computer interaction efficiency in the virtual scene. Meanwhile, the game progress can also be accelerated, thereby saving resource overheads of a server and a terminal device.

### BRIEF DESCRIPTION OF THE DRAWINGS

FIG. 1 is a schematic architectural diagram of a virtual scene interaction processing system 100 provided in an embodiment of this application.

FIG. 2 is a schematic structural diagram of an electronic device 500 provided in an embodiment of this application.

FIG. 3 is a first flowchart of a virtual scene interaction processing method provided in an embodiment of this application.

FIG. 4A is a schematic diagram of a first principle of a virtual scene interaction processing method provided in an embodiment of this application.

FIG. 4B is a schematic diagram of a first application scene of a virtual scene interaction processing method provided in an embodiment of this application.

FIG. 5 is a second flowchart of a virtual scene interaction processing method provided in an embodiment of this application.

FIG. 6A is a schematic diagram of a second application scene of a virtual scene interaction processing method provided in an embodiment of this application.

FIG. 6B is a schematic diagram of a third application scene of a virtual scene interaction processing method provided in an embodiment of this application.

FIG. 6C is a schematic diagram of a fourth application scene of a virtual scene interaction processing method provided in an embodiment of this application.

FIG. 6D is a schematic diagram of a fifth application scene of a virtual scene interaction processing method provided in an embodiment of this application.

FIG. 6E is a schematic diagram of a sixth application scene of a virtual scene interaction processing method provided in an embodiment of this application.

FIG. 6F is a schematic diagram of a seventh application scene of a virtual scene interaction processing method provided in an embodiment of this application.

FIG. 7A is a schematic diagram of a second principle of a virtual scene interaction processing method provided in an embodiment of this application.

FIG. 7B is a schematic diagram of a third principle of a virtual scene interaction processing method provided in an embodiment of this application.

FIG. 7C is a schematic diagram of a fourth principle of a virtual scene interaction processing method provided in an embodiment of this application.

FIG. 8 is a flowchart of a virtual scene interaction processing method provided in an embodiment of this application.

### DESCRIPTION OF EMBODIMENTS

To make the purpose, technical solutions, and advantages of this application clearer, this application will be further described below in detail in combination with the drawings. The described embodiments are not to be construed as limitations on this application. All other embodiments obtained by a person skilled in the art without contributing creative efforts shall fall within the protection scope of this application.

In the following description, the term “some embodiments” describes subsets of all possible embodiments, but the term “some embodiments” may be the same subset or different subsets of all the possible embodiments, and may be combined with each other without conflict.

In the embodiments of this application, when related data (such as data of a game character controlled by a user) such as user information is involved, when a specific product or technology is used in the embodiments of this application, a permission or consent of the user is required, and acquisition, use, and processing of the related data need to comply with the relevant laws and regulations and standards of the relevant countries and regions.

In the embodiments of this application, a term “module” or “unit” refers to a computer program having predetermined functions or a part of the computer program, operates with other relevant portions to achieve a predetermined objective, and may be fully or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including functions of the module or unit.

In the following description, the involved terms “first/second/, etc.” are merely intended to distinguish similar objects but do not indicate a specific order for the objects. The terms “first/second/, etc.” may be interchangeable in a specific order or sequence when permitted, so that the embodiments of this application described herein can be implemented in an order except those shown or described herein.

Unless otherwise defined, all technical and scientific terms used herein have the same meanings as those generally understood by a person skilled in the art in this application. The terms used herein are intended to merely describe the embodiments of this application, not to limit this application.

Before the embodiments of this application are further described in detail, nouns and terms involved in the embodiments of this application are described, and applicable to the following explanation.
1) The expression “in response to”: is configured for representing a condition or status on which to-be-performed operations depend. When the dependence condition or status is met, one or more operations may be performed in real time or at a set delay. Unless otherwise specified, there is no chronological limitation to the plurality of to-be-performed operations.
2) A virtual scene: is a scene displayed (or provided) when an application program runs on a terminal device. The scene may be a simulation environment for a real world, or may be a semi-simulation and semi-fictional virtual environment, or may be a completely fictional virtual environment. The virtual scene may be any one of a two-dimensional virtual scene, a 2.5-dimensional virtual scene, or a three-dimensional virtual scene. A dimension of the virtual scene is not limited in the embodiments of this application. For example, the virtual scene may include the sky, the land, the ocean, and the like. The land may include an environment element such as a desert and a city, and a user may control a virtual object to move in the virtual scene.
3) Virtual objects: are images of various persons and objects that may perform interaction in the virtual scene, or movable objects in the virtual scene. The movable objects may be virtual persons, virtual animals, cartoon persons, and the like, such as persons and animals displayed in the virtual scene. The virtual object may be a virtual image in a virtual scene for representing a user. The virtual scene may include a plurality of virtual objects. Each virtual object has a shape and a volume in the virtual scene, and occupies a part of space in the virtual scene. The virtual object may also be a game character controlled by a user (or referred to as a player).
4) Cloud gaming: also known as gaming on demand, refers to an example that a game program is deployed in a server and run (referred to as a game example). The game example transmits game data outputted in a running process to a browser page of a user terminal, and the page calls a media assembly of a browser to decode the game data, and renders a real-time game picture in a game process according to a decoding result. When the page monitors an operation performed by the user in the game picture, the page reports the operation to the game example run in the server. When the game data generated in the game example in response to the operation is received, the decoding and rendering process is repeated, so that the change in the game picture according to the operation of the user is presented on the page.

That is, the cloud gaming is an online gaming technology based on a cloud computing technology. The cloud gaming technology enables a thin client with relatively limited graphics processing and data computing capabilities to run high-quality games. In a cloud gaming scene, the game is not run in a user terminal (such as a player game terminal), but in a cloud server, and the cloud server renders the game scene into audio and video streams and transmits the audio and video streams to the user terminal through a network. In this way, the user terminal does not need to have strong graphics operation and data processing capabilities, and only needs to have a basic streaming media playing capability and the capabilities to acquire instructions inputted by the player and transmit the instructions to the cloud server.
5) An under-attack prompt control: is a prompt control configured to represent an attack direction and orientation of an attacker. For example, when the first virtual object is attacked by the second virtual object located on the left side, the under-attack prompt control may be displayed on the left side of the first virtual object, and a pointing direction of the under-attack prompt control is consistent with the attack direction of the second virtual object. For example, the second virtual object launches an attack to the first virtual object located on the right side, that is, the attack direction of the second virtual object is rightward. Therefore, the pointing direction of the under-attack prompt control is also rightward. That is, an attacked person may intuitively know the orientation and the attack direction of the attacker according to the under-attack prompt control.

Embodiments of this application provide a virtual scene interaction processing method and apparatus, an electronic device, a non-transitory computer-readable storage medium, and a computer program product, which can quickly and efficiently control the virtual object to turn to the attacker to facilitate the player to launch a counterattack, so as to improve the human-computer interaction efficiency in the virtual scene. The electronic device provided in an embodiment of this application is described below. The electronic device provided in this embodiment of this application may be implemented as a terminal device (corresponding to a stand-alone version/offline mode game application), or implemented collaboratively by a server and the terminal device (corresponding to a network version game application). The virtual scene interaction processing method, provided in this embodiment of this application, implemented collaboratively by the server and the terminal device is described below as an example.

Before the architecture of a virtual scene interaction processing system provided in this embodiment of this application is introduced, a game mode involved in this embodiment of this application is first introduced. A solution for collaborative implementation of the terminal device and the server mainly involves two game modes, i.e., a local game mode and a cloud gaming mode, respectively, where the local game mode means that the terminal device and the server cooperatively run the game processing logic. Operation instructions inputted into the terminal device by a player are partly processed by the game logic run by the terminal device and partly processed by the game logic run by the server. Moreover, the game logic processing run by the server is often more complex and requires to consume more computing power. The cloud gaming mode means that game logic processing is completely run by the server (such as a cloud server), and the cloud server renders game scene data into audio and video streams and then transmits the audio and video streams to the terminal device through a network for display. That is, the terminal device only needs to have the basic streaming media playing capability and the capabilities to acquire the operation instructions inputted by the player and transmit the instructions to the server.

The architecture of a virtual scene interaction processing system provided in this embodiment of this application is described below.

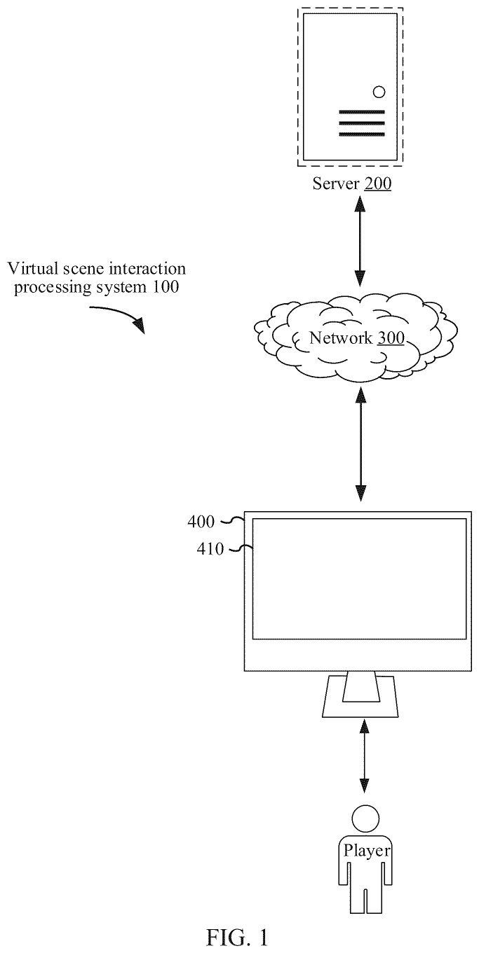

For example, FIG. 1 is a schematic architectural diagram of a virtual scene interaction processing system 100 provided in an embodiment of this application. To support an application that can quickly and efficiently control the virtual object to turn to the attacker to facilitate the player to launch a counterattack to improve the operation experience and game fun of the player significantly, as shown in FIG. 1, the virtual scene interaction processing system 100 includes: a server 200, a network 300, and a terminal device 400, where the network 300 may be a local area network, or a wide area network, or a combination thereof. The terminal device 400 is a terminal device associated with a current user (or referred to as a player). A client 410 runs on the terminal device 400. The client 410 may be various types of clients, e.g., including a shooting game client, an instant policy game client, a battle royale game client, a role-playing game client, and a browser.

In some embodiments, the virtual scene may be displayed on a human-computer interaction interface of the client 410, where the virtual scene may include a plurality of virtual objects including a first virtual object (such as a game character A controlled by a current player). The client 410, in response to a first virtual object being attacked by at least one second virtual object (such as a game character controlled by another player) in the virtual scene, displays at least one corresponding under-attack prompt control in the virtual scene, where a pointing direction of each under-attack prompt control is consistent with an attack direction of the corresponding second virtual object; then, the client 410 may control, in response to a trigger operation of a current player for a target under-attack prompt control, the first virtual object to turn to a target direction, where the target under-attack prompt control is an under-attack prompt control selected by the current player among the at least one under-attack prompt control, and the target direction is a direction opposite to a pointing direction of the target under-attack prompt control, i.e., a direction facing the second virtual object (i.e., the selected attacker) corresponding to the target under-attack prompt control. In this way, the virtual object can be quickly and efficiently controlled to turn to the attacker, which facilitates the player to launch a counterattack, so as to improve the human-computer interaction efficiency in the virtual scene.

The virtual scene in the virtual scene interaction processing method provided in this embodiment of this application may be outputted completely based on the terminal device, or outputted collaboratively based on the terminal device and the server. For example, the calculation and output of related data of the virtual scene may be completed completely depending on the computing power of graphics processing hardware of the terminal device 400, where the graphics processing hardware includes types of a central processing unit (CPU) and a graphics processing unit (GPU). For example, when a visual perception of the virtual scene is formed, the terminal device 400 computes, through the graphics computing hardware, data required for display, completes loading, parsing, and rendering of the displayed data, outputs video frames capable of forming the visual perception for the virtual scene on graphics output hardware, for example, presents two-dimensional video frames on a display screen of a smartphone, or projects video frames for implementing a three-dimensional display effect on lenses of augmented reality/virtual reality glasses. In addition, to enrich a perception effect, the terminal device 400 may also form one or more of an auditory perception, a tactile perception, a motion perception, and a taste perception through different hardware.

Of course, the virtual scene calculation may also be completed depending on the computing power of the server 200, and the virtual scene is outputted on the terminal device 400. For example, taking the formation of the visual perception of the virtual scene as an example, the server 200 computes the related displayed data of the virtual scene (such as scene data) and transmits the data to the terminal device 400 through the network 300. The terminal device 400 computes, loads, parses, and renders the displayed data depending on the graphics computing hardware, and outputs the virtual scene depending on the graphics output hardware to form the visual perception, for example, may present the two-dimensional video frames on the display screen of the smartphone, or projects the video frames for implementing the three-dimensional display effect on the lenses of the augmented reality/virtual reality glasses. The perception in the form of the virtual scene may be outputted through corresponding hardware of the terminal device 400. For example, an auditory perception is formed by using a microphone, and a tactile perception is formed by using a vibrator.

In some other embodiments, the embodiments of this application may also be implemented through a cloud technology. The cloud technology is a hosting technology that unifies a series of resources such as hardware, software, and networks in a wide area network or a local area network to implement computing, storage, processing, and sharing of data.

The cloud technology is a general term for a network technology, an information technology, an integration technology, a management platform technology, and an application technology which are applied based on a cloud computing business mode. The technologies may form a resource pool and used as needed, which is flexible and convenient. The cloud computing technology will become important support. A background service of a technical network system needs a large quantity of computing and storage resources.

For example, the server 200 in FIG. 1 may be an independent physical server, or may be a server cluster composed of a plurality of physical servers, or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device 400 may be a smartphone, a tablet computer, a laptop, a desktop computer, a smart speaker, a smartwatch, an in-vehicle terminal, and the like, but is not limited thereto. The terminal device 400 and the server 200 may be directly or indirectly connected through wired or wireless communication, which is not limited in this embodiment of this application.

In some embodiments, the terminal device or the server may also implement the virtual scene interaction processing method provided in this embodiment of this application by running various computer-executable instructions or a computer program. For example, the computer-executable instructions may be microprogram-level commands, machine instructions, or software instructions. The computer program may be a native program or a software module in an operating system; may be a native application (APP), i.e., a program that needs to be installed in the operating system to run, such as a policy game APP (i.e., the client 410 above); or may be an applet that may be embedded into any APP, i.e., a program that only needs to be downloaded into a browser environment to run. To sum up, the above computer-executable instructions may be instructions in any form, and the above computer program may be an application, a module, or a plugin in any form.

With the computer program being an application as an example, in practical implementation, the terminal device 400 installs and runs an application that supports the virtual scene. The application may be any one of a multiplayer battle policy game, a virtual reality application, a three-dimensional map program, an adventure game, a massive multiplayer online role-playing game, or a multiplayer gunfight survival game. The user uses the terminal device 400 to operate the virtual objects located in the virtual scene for performing activities. The activities include, but are not limited to: at least one of adjusting body postures, crawling, walking, running, riding, jumping, driving, picking, shooting, attacking, throwing, and constructing virtual buildings. For example, the virtual objects may be virtual persons, such as simulated person characters or cartoon person characters.

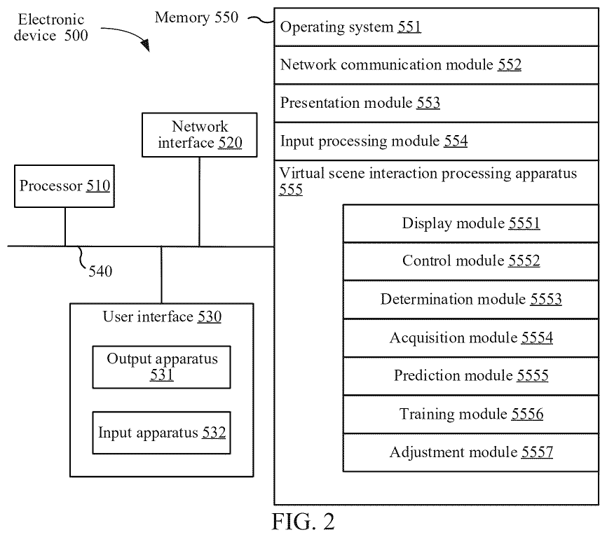

The structure of the electronic device provided in this embodiment of this application is described below. With the electronic device being a terminal device as an example, FIG. 2 is a schematic structural diagram of an electronic device 500 provided in an embodiment of this application. The electronic device 500 shown in FIG. 2 includes: at least one processor 510, a memory 550, at least one network interface 520, and a user interface 530. Components in the electronic device 500 are coupled together through a bus system 540. The bus system 540 is configured to implement connection and communication between the components. In addition to a data bus, the bus system 540 further includes a power bus, a control bus, and a state signal bus. However, for clear description, various buses are marked as the bus system 540 in FIG. 2.

The processor 510 may be an integrated circuit chip, and has a signal processing capability, such as a general-purpose processor, a digital signal processor (DSP), or other programmable logic devices, a discrete gate or a transistor logic device, or a discrete hardware assembly, where the general-purpose processor may be a microprocessor or any conventional processor.

The user interface 530 includes one or more output apparatuses 531 that enable presentation of media content, including one or more loudspeakers and/or one or more visual display screens. The user interface 530 further includes one or more input apparatuses 532, including a user interface component conducive to user input, such as a keyboard, a mouse, a microphone, a touch display screen, a camera, other input buttons, and a control.

The memory 550 may be a removable memory, a non-removable memory, or a combination thereof. Exemplary hardware devices include a solid-state memory, a hard-disk drive, an optical disc drive, and the like. In some embodiments, the memory 550 includes one or more storage devices that are physically away from the processor 510.

The memory 550 includes a volatile memory or a non-volatile memory, or may include both a volatile memory and a non-volatile memory. The non-volatile memory may be a read only memory (ROM), and the volatile memory may be a random access memory (RAM). The memory 550 described in this embodiment of this application is intended to include any suitable type of memories.

In some embodiments, the memory 550 can store data to support various operations. Examples of the data include a program, a module, and a data structure, or a subset or a superset thereof, which are described below.

An operating system 551 includes system programs configured for processing various basic system services and performing hardware-related tasks, such as a framework layer, a core library layer, and a drive layer for implementing various basic services and processing hardware-based tasks.

A network communication module 552 is configured to reach other computing devices through one or more (wired or wireless) network interfaces 520. An exemplary network interface 520 includes: Bluetooth, wireless fidelity (WiFi), and a universal serial bus (USB).

A presentation module 553 is configured to present information through one or more output apparatuses 531 (such as a display screen and a loudspeaker) associated with the user interface 530 (such as a user interface configured to operate a peripheral device and display content and information).

An input processing module 554 is configured to detect one or more user inputs or interactions from one or more input apparatuses 532 and translate the detected inputs or interactions.

In some embodiments, the apparatus provided in this embodiment of this application may be implemented in a software mode. FIG. 2 shows a virtual scene interaction processing apparatus 555 stored in the memory 550, which may be software in the form of a program and a plugin, and includes the following software modules: a display module 5551, a control module 5552, a determination module 5553, an acquisition module 5554, a prediction module 5555, a training module 5556 and an adjustment module 5557. These modules are logical, and thus may be combined or further split in different manners according to the functions to be implemented. For convenience of expression, all the above modules are shown at a time in FIG. 2. However, the virtual scene interaction processing apparatus 555 is not to be considered as excluding implementations that may include only the display module 5551 and the control module 5552, and the functions of the modules will be described below.

The virtual scene interaction processing method provided in this embodiment of this application is described in detail below in combination with the exemplary application and implementation of the terminal device provided in this embodiment of this application.

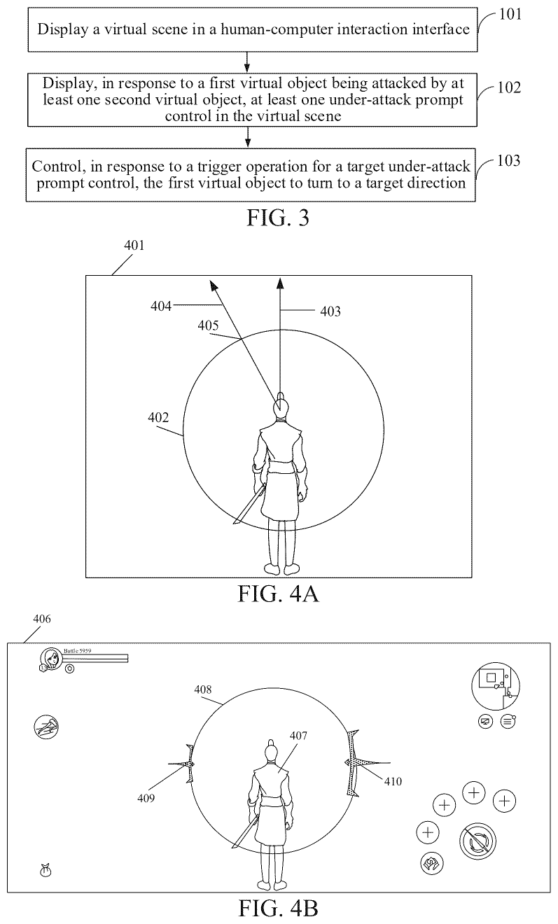

FIG. 3 is a first flowchart of a virtual scene interaction processing method provided in an embodiment of this application, which will be described in combination with operations shown in FIG. 3.

The method shown in FIG. 3 may be performed by various forms of computer programs run by the terminal device, not limited to a client, and for example, may also be the operating system, the software module, the script, and the applet described above. Therefore, the following example of the client is not to be considered as a limitation to the embodiments of this application. In addition, for convenience of expression, the terminal device and the client running on the terminal device are not specifically distinguished hereinafter.

In operation 101, a virtual scene is displayed in a human-computer interaction interface.

Herein, the virtual scene may include a plurality of virtual objects including the first virtual object (such as a game character A controlled by a current player).

In some embodiments, a client may run on a terminal device (i.e., a terminal device configured to perform an operation in the virtual scene and held by a current player) associated with a current player (i.e., a user that holds a terminal device serving as an execution body), and a plurality of virtual objects, which for example may be a plurality of virtual objects participating in the same virtual battle, including the first virtual object (such as a game character A) controlled by the current player may be displayed on a human-computer interaction interface of the client. For example, taking the client being a massive multiplayer online role-playing game APP as an example, the massive multiplayer online role-playing game APP can run on a terminal device (such as a mobile phone) associated with a player. When a click operation performed by the player on an APP icon is received, the virtual scene may be displayed on a screen (i.e., a human-computer interaction interface of the massive multiplayer online role-playing game APP) of the terminal device, where the virtual scene may include a plurality of game characters including a game character controlled by the current player.

In some embodiments, the virtual scene may be displayed in the human-computer interaction interface of the client from a first-person view (for example, a virtual object in the game is played from a perspective of the current player); the virtual scene may be displayed from a third-person view (for example, the player runs after a virtual object in the game to play the game); or the virtual scene may be displayed from a large aerial view, where the above different views can be switched in different manners according to a view switching instruction (such as a click operation on a “Tab” key on the keyboard) triggered by the player. For example, assuming that the current perspective is the first-person view, and when the click operation performed by the player on the “Tab” key is received, the first-person view may be switched to the third-person view. When the click operation performed by the player on the “Tab” key is received again, the third-person view may be switched to the large aerial view.

For example, the first virtual object may be a virtual object controlled by the current user in the game. Certainly, the virtual scene may further include other virtual objects, such as virtual objects that may be controlled by another user or controlled by a robot program. The virtual objects may be grouped into any one of a plurality of teams. The teams can be in an adversarial relationship or collaborative relationship. The teams in the virtual scene may include one or all of the above relationships.

Taking an example in which the virtual scene is displayed from the first-person view, displaying the virtual scene in the human-computer interaction interface may include: determining a field of view region of the first virtual object according to a viewing position and a field of view of the first virtual object in the entire virtual scene (i.e., the range of the scene that can be captured by a virtual camera bound to the first virtual object in the virtual scene, and the size of the field of view directly determines the size of the scene the player can see), and presenting a part of the virtual scene located in a field of view region in the entire virtual scene, i.e., the displayed virtual scene may be a part of the virtual scene relative to a panoramic virtual scene. Because the first-person view is a viewing angle which is the most impactful for the user, the user can have an immersive perception during the operation process.

Taking an example in which the virtual scene is displayed from the large aerial view, displaying the virtual scene in the human-computer interaction interface may include: presenting, in response to the zooming operation on a panoramic virtual scene, a part of the virtual scene corresponding to a zooming operation in the human-computer interaction interface i.e., the displayed virtual scene may be a part of the virtual scene relative to the panoramic virtual scene. In this way, the operability of the user during the operation process can be improved, thereby improving the human-computer interaction efficiency. In addition, the above different perspectives may also be switched. For example, assuming that the virtual scene is currently displayed from the first-person view, when a perspective switching operation triggered by the player is received, the first-person view may be switched to the large aerial view.

In operation 102, at least one under-attack prompt control is displayed in the virtual scene in response to the first virtual object being attacked by at least one second virtual object.

Herein, the pointing direction of each under-attack prompt control (such as an under-attack prompt button) is consistent with the attack direction of a corresponding second virtual object. For example, assuming that the attack direction of the second virtual object is leftward (i.e., the first virtual object is located on the left side of the second virtual object, and the second virtual object launches an attack to the first virtual object located on the left side), the pointing direction of the under-attack prompt control is also leftward (for example, the pointing direction of an arrow included in the under-attack prompt control is leftward).

In some embodiments, the displaying at least one under-attack prompt control in the virtual scene may be implemented in the following mode: displaying in a plane of the human-computer interaction interface an under-attack prompt region (such as a circular or rectangular region) centered on the first virtual object (such as a head or a body of the first virtual object); determining, for each second virtual object, an included angle between a direction opposite to an attack direction of the second virtual object and a current orientation of the first virtual object; and determining a position corresponding to the included angle in the under-attack prompt region and displaying in the position the under-attack prompt control corresponding to the second virtual object.

In some other embodiments, following the above example, the determining a position corresponding to the included angle in the under-attack prompt region may be implemented in the following mode: starting, in a plane in which the human-computer interaction interface is located (such as a plane in which the first virtual object in the virtual scene is located, which is perpendicular to a horizontal plane of the virtual scene), from the first virtual object (such as a head of the first virtual object), emitting a detection ray in a direction that is offset counterclockwise from a reference direction by the included angle (which may be, for example, a vertical upward direction in the plane), the reference direction being a direction corresponding to the current orientation of the first virtual object in the plane (for example, a direction obtained by rotating the current orientation of the first virtual object upward by 90 degrees may be used as the reference direction, i.e., the reference direction is a direction that is perpendicular to the current orientation of the first virtual object and is upward, and the upward direction herein refers to a direction pointing to the head of the first virtual object); and determining an intersection point of the detection ray and an edge of the under-attack prompt region as the position corresponding to the included angle in the under-attack prompt region.

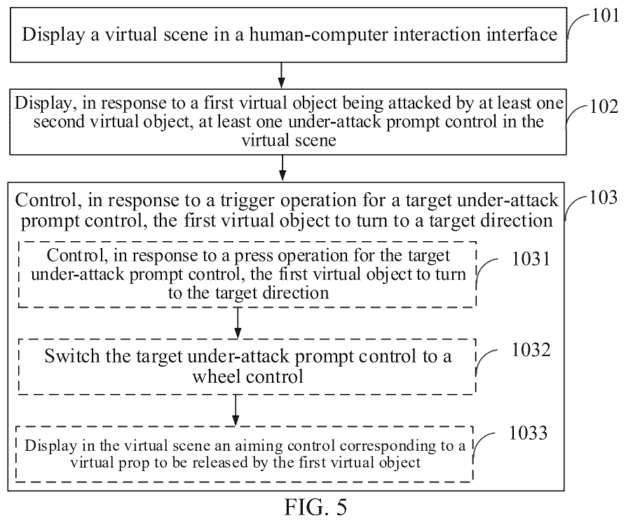

For example, taking an example in which the first virtual object is a game character A controlled by a player 1, and the at least one second virtual object is a game character B controlled by a player 2, when detecting that the game character A controlled by the player 1 is attacked by the game character B controlled by the player 2, for example, a virtual bullet emitted by the game character B hits the game character A, as shown in FIG. 4A, the under-attack prompt region 402 centered on a head of the game character A (which may be, for example, a circular region with the head of the game character A as a center of a circle and having a radius R) may be displayed in a plane 401 in which the human-computer interaction interface is located. Then, an included angle (assumed to be 30°) between a direction opposite to the attack direction of the game character B and a current orientation of the game character A (the current orientation of the game character A is assumed to be perpendicular to paper inward) may be calculated. Subsequently, in the plane 401 in which the human-computer interaction interface is located, starting from the head of the game character A, a detection ray 404 may be emitted in a direction 30° counterclockwise offset from a vertical upward direction 403 (i.e., the reference direction) in the plane 401, and the under-attack prompt control corresponding to the game character B is displayed at a position of an intersection point 405 between the detection ray 404 and an edge of the under-attack prompt region 402. That is, the position in which the under-attack prompt control is displayed in the virtual scene corresponds to a relative position relationship between the attacker (i.e., the second virtual object) and the first virtual object. For example, when the attacker (i.e., the second virtual object) is located on the left side of the first virtual object in the virtual scene, the under-attack prompt control is displayed on the left side of the first virtual object, and when the attacker is located on the right side of the first virtual object in the virtual scene, the under-attack prompt control is displayed on the right side of the first virtual object. In this way, the player may intuitively know the orientation of the attacker according to the position of the under-attack prompt control, which facilitates subsequent counterattack by the player, thereby further improving the human-computer interaction efficiency in the virtual scene.

In some embodiments, the displaying at least one under-attack prompt control in the virtual scene may also be implemented in the following mode: for each second virtual object, performing the following processing: acquiring a distance between the second virtual object and the first virtual object in the virtual scene; determining a size matching the distance, the size being negatively correlated with the distance (i.e., the longer the distance, the smaller the size; for example, when the distance between the second virtual object and the first virtual object is 50 meters, the length of the under-attack prompt control may be 10 centimeters and the width may be 8 centimeters; and when the distance between the second virtual object and the first virtual object is 30 meters, the length of the under-attack prompt control may be 15 centimeters and the width may be 10 centimeters); and displaying in the virtual scene the under-attack prompt control corresponding to the second virtual object and conforming to the size. That is, the second virtual object closer to the first virtual object corresponds to a more significant under-attack prompt control, which is convenient for the player to know the distance between the attacker and the player based on the size of the under-attack prompt control, so as to provide a strong reference for subsequent decisions.

For example, FIG. 4B is a schematic diagram of a first application scene of a virtual scene interaction processing method provided in an embodiment of this application. As shown in FIG. 4B, the first virtual object 407 (such as a game role A controlled by a player 1) is displayed in a virtual scene 406. When detecting that the first virtual object 407 is attacked by at least one second virtual object (such as a game character B controlled by a player 2 and a game character C controlled by a player 3), an under-attack prompt region 408 (such as a circular region) centered on a head of the first virtual object 407 may be displayed, and an under-attack prompt control 409 corresponding to the game character B and an under-attack prompt control 410 corresponding to the game character C are displayed at corresponding positions of the under-attack prompt region 408, respectively. For example, if the game character B is located on the left side of the game character A, the under-attack prompt control 409 corresponding to the game character B may be displayed on the left side of the game character A, and a pointing direction of the under-attack prompt control 409 is consistent with an attack direction of the game character B (the game character B launches an attack to the game character A located on the right side of the game character B, i.e., the attack direction is rightward) (i.e., the pointing direction of the under-attack prompt control 409 is also rightward). Similarly, assuming that a game character C is located on the right side of the game character A, the under-attack prompt control 410 corresponding to the game character C may be displayed on the right side of the game character A, and the pointing direction of the under-attack prompt control 410 is consistent with an attack direction of the game character C (the game character C launches an attack to the game character A located on the left side of the game character C, i.e., the attack direction is leftward) (i.e., the pointing direction of the under-attack prompt control 410 is leftward). In addition, distances from the game character A to the game character B and the game character C may be further acquired. For example, assuming that the distance between the game character A and the game character B is 100 meters, and the distance between the game character A and the game character C is 60 meters, i.e., the game character C is closer to the game character A, the size of the under-attack prompt control 410 corresponding to the game character C and displayed in the virtual scene 406 may be greater than the size of the under-attack prompt control 409 corresponding to the game role B. In this way, the player 1 may intuitively know the distances from the game character B and the game character C to the own character (i.e., the game character A) according to the under-attack prompt control 409 and the under-attack prompt control 410, to provide a reference for subsequent decisions of the player 1.

In some other embodiments, the displaying at least one under-attack prompt control in the virtual scene may also be implemented in the following mode: for each second virtual object, performing the following processing: acquiring, in response to the second virtual object attacking the first virtual object, a damage value caused by the second virtual object to the first virtual object; determining a size matching the damage value, the size being positively correlated with the damage value (i.e., the larger the damage value, the larger the size; for example, when the second virtual object causes 100-point damage to the first virtual object, the length of the under-attack prompt control may be 10 centimeters and the width may be 8 centimeters; and when the second virtual object causes 200-point damage to the first virtual object, the length of the under-attack prompt control may be 15 centimeters and the width may be 10 centimeters); and displaying in the virtual scene the under-attack prompt control corresponding to the second virtual object and conforming to the size. That is, when the game character controlled by the player is attacked by a plurality of game characters controlled by a plurality of other players at the same time, respectively, the greater the damage caused to the game character controlled by the player, the larger the size of the corresponding under-attack prompt control (i.e., the more significant the under-attack prompt control). In this way, the player conveniently and intuitively knows, based on the under-attack prompt control, an attacker that poses the greatest threat to the player currently, which provides a strong reference for a subsequent counterattack policy.

For example, taking an example in which the first virtual object is a game character A controlled by a player 1, and at least one second virtual object is a game character B controlled by a player 2 and a game character C controlled by a player 3, a when detecting that the game character A controlled by the player 1 is attacked by both the game character B controlled by the player 2 and the game character C controlled by the player 3, for example, assuming that the game character A is hit by virtual bullets emitted by both the game character B and the game character C, damage values caused by the game character B and the game character C to the game character A may be obtained, respectively; for example, assuming that the game character B causes 100-point damage to the game character A, and the game character C causes 50-point damage to the game character A, the size of the under-attack prompt control corresponding to the game character B may be greater than the size of the under-attack prompt control corresponding to the game character C. In this way, the player 1 may intuitively know, based on the under-attack prompt control corresponding to the game character B and the under-attack prompt control corresponding to the game character C, that the game character B currently has a higher threat to the game character A, so as to preferentially launch a counterattack to the game character B.

In the embodiments of this application, the size of the under-attack prompt control may be comprehensively determined according to the distance between the second virtual object and the first virtual object and the damage value caused by the second virtual object to the first virtual object. For example, weighted summation may be performed on the distance and the damage value, and the size of the under-attack prompt control is determined according to a weighted summation result, which is not specifically limited in the embodiments of this application.

In addition, when detecting that the first virtual object is attacked by a plurality of second virtual objects at the same time, under-attack prompt controls corresponding to the second virtual objects may be displayed. For example, assuming that the first virtual object is attacked by five second virtual objects at the same time, five under-attack prompt controls may be displayed in the virtual scene. Certainly, to avoid interference caused to normal game behaviors of the player due to the display of excessive under-attack prompt controls, only the under-attack prompt controls corresponding to part of the second virtual objects among the plurality of second virtual objects may be displayed. Details are described below.

In some embodiments, when the number of at least one second virtual object is multiple, the displaying at least one under-attack prompt control in the virtual scene may also be implemented in the following mode: acquiring, in response to a plurality of second virtual objects attacking the first virtual object, damage values caused by the second virtual objects to the first virtual object, respectively; and displaying in the virtual scene the under-attack prompt control corresponding to a target second virtual object, the target second virtual object being the second virtual object in the plurality of second virtual objects having the damage value caused to the first virtual object greater than a damage value threshold. When the damage values caused by the plurality of second virtual objects to the first virtual object are all less than the damage value threshold, the second virtual object having a maximum damage value caused to the first virtual object may be used as the target second virtual object.

For example, taking an example in which the first virtual object is a game character A controlled by a player 1, and a plurality of second virtual objects are respectively a game character B controlled by a player 2, a game character C controlled by a player 3, and a game character D (i.e., a non-player character) controlled by artificial intelligence (such as a robot), when detecting that the game character A is attacked by the game character B, the game character C, and the game character D at the same time, for example, assuming that the game character A is hit by virtual bullets emitted by the game character B, the game character C and the game character D, damage values caused by the game character B, the game character C and the game character D to the game character A may be obtained, respectively; for example, assuming that the game character B causes 60-point damage to the game character A, the game character C causes 90-point damage to the game character A, and the game character D causes 30-point damage to the game character A, an under-attack prompt control corresponding to the game character C (i.e., the game character that causes the maximum damage value to the game character A) may be displayed only in the virtual scene. In this way, when the player is attacked by a plurality of attackers at the same time, only the under-attack prompt control corresponding to the attacker that poses the greatest threat to the player may be displayed in the virtual scene to avoid interference to the player due to the display of a plurality of under-attack prompt controls, while satisfying the counterattack requirement of the player.

In some other embodiments, when the number of at least one second virtual object is multiple, the displaying at least one under-attack prompt control in the virtual scene may also be implemented in the following mode: acquiring distances between the first virtual object and a plurality of second virtual objects in the virtual scene, respectively; determining, according to the distances, a target second virtual object located within an attack range of the first virtual object among the plurality of second virtual objects; and displaying in the virtual scene an under-attack prompt control corresponding to the target second virtual object.

For example, taking an example in which the first virtual object is a game character A controlled by a player 1, and a plurality of second virtual objects are respectively a game character B controlled by a player 2, a game character C controlled by a player 3, and a game character D controlled by a player 4, when detecting that the game character A controlled by the player 1 is attacked by the game character B, the game character C, and the game character D at the same time, distances from the game character A to the game character B, the game character C, and the game character D may be acquired, respectively. For example, assuming that the distance between the game character A and the game character B is 80 meters, the distance between the game character A and the game character C is 70 meters, and the distance between the game character A and the game character D is 100 meters, and an attack distance of the game character A may also be acquired, for example, assuming that the attack distance of the game character A is 75 meters, that is, only when the game character C is located within an attack range of the game character A, that is, the game character B and the game character D are located outside the attack range of the game character A, only the under-attack prompt control corresponding to the game character C may be displayed in the virtual scene, which facilitates the player 1 to launch a counterattack against an attacker that can be attacked.

In some embodiments, when the number of at least one second virtual object is multiple, the displaying at least one under-attack prompt control in the virtual scene may also be implemented in the following mode: based on feature information corresponding to the plurality of second virtual objects, calling the first machine learning model for prediction to obtain hazard parameters of the second virtual objects for the first virtual object (where the hazard parameter may be configured for representing a probability that the second virtual object kills the first virtual object, i.e., a larger hazard parameter represents a higher probability of successfully killing the first virtual object), where the feature information may include at least one of the following: distances from the first virtual object, skills of the second virtual objects, and virtual props held by the second virtual objects; and displaying in the virtual scene an under-attack prompt control corresponding to the target second virtual object, the target second virtual object being a second virtual object with a hazard parameter greater than a hazard parameter threshold among the plurality of second virtual objects. When a plurality of hazard parameters respectively corresponding to the plurality of second virtual objects are less than the hazard parameter threshold, the second virtual object corresponding to a largest hazard parameter may be used as the target second virtual object.

For example, taking an example in which the first virtual object is a game character A controlled by a player 1, and a plurality of second virtual objects are respectively a game character B controlled by a player 2, a game character C controlled by a player 3, and a game character D controlled by a player 4, when detecting that the game character A controlled by the player 1 is attacked by the game character B, the game character C, and the game character D at the same time, for example, assuming that the game character A is hit by virtual props (such as virtual bullets) emitted by the game character B, the game character C, and the game character D at the same time, based on feature information (for example, including a distance to the game character A, skills possessed, and a type of a virtual prop held) respectively corresponding to the game character B, the game character C, and the game character D, the first machine learning model may be called for prediction to obtain hazard parameters of the game character B, the game character C, and the game character D for the game character A. For example, assuming that the hazard parameter of the game character B for the game character A is 78% (i.e., a probability that the game character B kills the game character A is 78%), the hazard parameter of the game character C for the game character A is 89% (i.e., a probability that the game character C kills the game character A is 89%), and the hazard parameter of the game character D for the game character A is 96% (i.e., a probability that the game character D kills the game character A is 96%), and also assuming that a preset hazard parameter threshold is 90%, only an under-attack prompt control corresponding to the game character D may be displayed in the virtual scene, so as to avoid interference to the player due to the display of excessive under-attack prompt controls, and to satisfy a requirement of the player for launching a counterattack against an attacker that poses the highest threat.

In some other embodiments, following the above example, before calling the first machine learning model for prediction, the following processing may also be performed: acquiring a sample first virtual object and a plurality of sample second virtual objects, each of the sample second virtual objects being labeled with a hazard parameter for the sample first virtual object; based on feature information corresponding to the plurality of sample second virtual objects, calling the initialized first machine learning model for prediction to obtain a hazard parameter of each of the sample second virtual objects for the sample first virtual object; determining errors between the predicted hazard parameters and the pre-labeled hazard parameters; and performing backpropagation based on the errors, and updating the parameters of the first machine learning model during the backpropagation process.

The principle of the above backpropagation is described below. Training sample data is inputted into an input layer of the machine learning model, passes through a hidden layer, and finally reaches an output layer, and a result is outputted. This is a forward propagation process of the machine learning model. Because there is an error between the output result of the initialized machine learning model and an actual result, the error between the output result and an actual value is calculated, and back propagated from the output layer to the hidden layer until the error is propagated to the input layer. In the backpropagation process, a value of a machine learning model parameter is adjusted according to the error, that is, a loss function is constructed according to the error between the output result and the actual value, a partial derivative of the loss function for the model parameter is calculated layer by layer, and a gradient of the loss function for each layer of the model parameter is generated. Because a direction of the gradient indicates a direction of error expansion, the gradient of the model parameter is inverted, and summed with an original parameter of each layer of the model, and an obtained summation result is used as an updated model parameter in each layer, so as to reduce the error caused by the model parameters. The above process is continuously iterated until convergence occurs.

For example, an exemplary structure of the above first machine learning model may include: an input layer (i.e., an embedding layer), an encoding layer (which may be, for example, composed of a plurality of cascaded convolutional layers), a fully connected layer, and an output layer (including an activation function, such as a Softmax function). After the feature information corresponding to a plurality of sample second virtual objects is acquired, the feature information corresponding to the plurality of sample second virtual objects can be firstly inputted into the input layer for embedding processing. Then, embedded feature vectors outputted by the input layer may be encoded through the encoding layer to obtain hidden layer feature vectors. Subsequently, the hidden layer feature vectors can be fully connected through the fully connected layer. Finally, a fully connected result outputted by the fully connected layer may be inputted into the output layer so that the output layer performs activation processing to obtain the hazard parameter of each sample second virtual object for the sample first virtual object. After a predicted hazard parameter is obtained, the predicted hazard parameter and a pre-labeled hazard parameter may be substituted into the loss function to obtain a corresponding difference, and backpropagation may be performed based on the difference, so that the parameters of the first machine learning model may be updated layer by layer in a backpropagation process, to obtain the trained first machine learning model.

The above first machine learning model may be a neural network model (such as a convolutional neural network, a deep convolutional neural network, or a fully connected neural network), a decision tree model, a gradient lifting tree, a multilayer perceptron, and a support vector machine. The type of the first machine learning model is not specifically limited in the embodiments of this application.

In operation 103, the first virtual object is controlled to turn to a target direction in response to a trigger operation for a target under-attack prompt control.

Herein, the target under-attack prompt control is a selected under-attack prompt control among the at least one under-attack prompt control, and the target direction is the direction opposite to the pointing direction of the target under-attack prompt control, i.e., to face a direction of the second virtual object corresponding to the target under-attack prompt control.

In some embodiments, taking an example in which the first virtual object is a game character A controlled by a player 1, and at least one second virtual object is respectively a game character B controlled by a player 2, a game character C controlled by a player 3, and a game character D controlled by a player 4, when detecting that the game character A is attacked by the game character B, the game character C, and the game character D at the same time, three under-attack prompt controls corresponding to the three game characters may be displayed in the virtual scene, and assumed to be an under-attack prompt control 1, an under-attack prompt control 2, and an under-attack prompt control 3 respectively, where the under-attack prompt control 1 corresponds to the game character B, the under-attack prompt control 2 corresponds to the game character C, and the under-attack prompt control 3 corresponds to the game character D. Assuming that the player 1 currently wants to launch a counterattack against the game character B controlled by the player 2, the player 1 may click the under-attack prompt control 1 corresponding to the game character B, and when a click operation of the player 1 for the under-attack prompt control 1 is received, the game character A may be controlled to turn to face the direction of the game character B, so that the player 1 may control the game character A to launch a counterattack against the game character B controlled by the player 2.

In some embodiments, the target under-attack prompt control may be manually selected by the player, and before the response to the trigger operation for the target under-attack prompt control, the following processing may be further performed: taking, in response to a selection operation for the at least one under-attack prompt control, the selected under-attack prompt control as the target under-attack prompt control, and switching a display mode of the target under-attack prompt control to a highlight mode (such as highlighting display or flashing display) different from display modes of other under-attack prompt controls, where other under-attack prompt controls are under-attack prompt controls except the target under-attack prompt control.

For example, taking an example in which at least one under-attack prompt control is three under-attack prompt controls, the three under-attack prompt controls are assumed to be an under-attack prompt control 1, an under-attack prompt control 2, and an under-attack prompt control 3 respectively, where the under-attack prompt control 1 may correspond to the game character B, the under-attack prompt control 2 may correspond to the game character C, and the under-attack prompt control 3 may correspond to the game character D. When a selection operation of the player for the under-attack prompt control 1 is received, the display mode of the under-attack prompt control 1 may be switched to a highlight mode different from the under-attack prompt control 2 and the under-attack prompt control 3. For example, the under-attack prompt control 1 may be switched to the highlighting display mode to remind the player that the under-attack prompt control 1 is the selected target under-attack prompt control.

In some other embodiments, the target under-attack prompt control may also be automatically selected based on an artificial intelligence mode. Before the response to a trigger operation for a target under-attack prompt control, the following processing may further be performed: based on feature information corresponding to the at least one under-attack prompt control respectively, calling the second machine learning model for prediction to obtain selection probabilities corresponding to the under-attack prompt controls, where the feature information may include at least one of the following: a distance between the second virtual object corresponding to the under-attack prompt control and the first virtual object, skills of the second virtual object corresponding to the under-attack prompt control, and virtual props held by the second virtual object corresponding to the under-attack prompt control; and taking an under-attack prompt control corresponding to a maximum selection probability as the target under-attack prompt control, and switching a display mode of the target under-attack prompt control to a highlight mode different from display modes of other under-attack prompt controls, the other under-attack prompt controls being under-attack prompt controls except the target under-attack prompt control among the at least one under-attack prompt control.

For example, taking an example in which at least one under-attack prompt control is three under-attack prompt controls, the three under-attack prompt controls are assumed to be an under-attack prompt control 1, an under-attack prompt control 2, and an under-attack prompt control 3 respectively, where the under-attack prompt control 1 may correspond to the game character B, the under-attack prompt control 2 may correspond to the game character C, and the under-attack prompt control 3 may correspond to the game character D. Based on the feature information corresponding to the three under-attack prompt controls respectively, the second machine learning model may be called for prediction to obtain selection probabilities corresponding to the under-attack prompt controls respectively. For example, assuming that the selection probability corresponding to the under-attack prompt control 1 is 89%, the selection probability corresponding to the under-attack prompt control 2 is 78%, and the selection probability corresponding to the under-attack prompt control 3 is 95%, the under-attack prompt control (i.e., the under-attack prompt control 3) having a maximum selection probability may be used as a target under-attack prompt control. For example, the display mode of the under-attack prompt control 3 may be switched to the highlight mode (such as a highlighting mode) different from the under-attack prompt control 1 and the under-attack prompt control 2 to remind the player that the game character (i.e., the game character D) corresponding to the under-attack prompt control 3 is a game character that poses the greatest threat to the player currently, which provides a reference for a subsequent counterattack policy of the player.

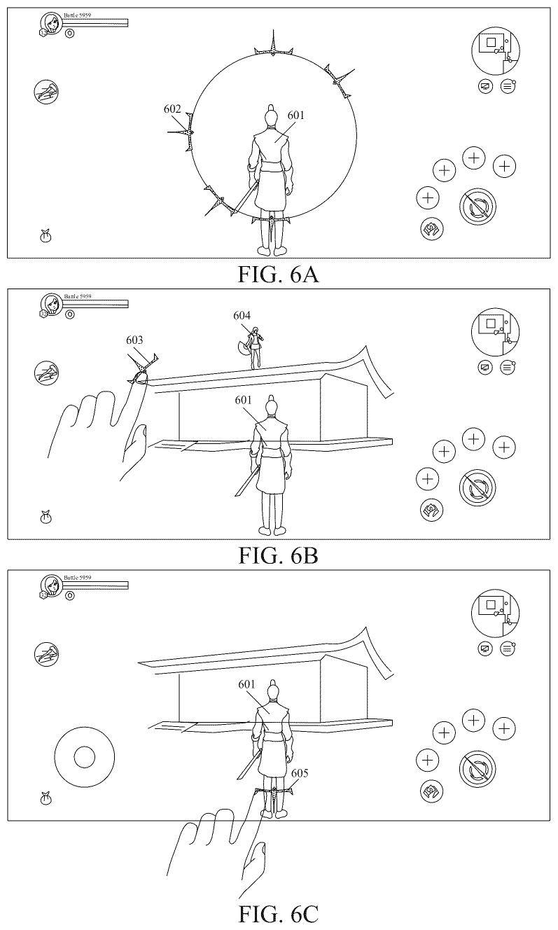

In some other embodiments, the trigger operation may include a press operation. FIG. 5 is a second flowchart of a virtual scene interaction processing method provided in an embodiment of this application. As shown in FIG. 5, operation 103 shown in FIG. 3 may also be implemented through operation 1031 to operation 1033 shown in FIG. 5, and will be described in combination with operations shown in FIG. 5.

In operation 1031, the first virtual object is controlled to turn to the target direction in response to the press operation for the target under-attack prompt control.

In some embodiments, taking an example in which at least one under-attack prompt control is three under-attack prompt controls, the three under-attack prompt controls are assumed to be an under-attack prompt control 1, an under-attack prompt control 2, and an under-attack prompt control 3 respectively, where the under-attack prompt control 1 may correspond to the game character B, the under-attack prompt control 2 may correspond to the game character C, and the under-attack prompt control 3 may correspond to the game character D. When the press operation performed by the player for the under-attack prompt control 1 (i.e., a target under-attack prompt control manually selected by the player) is received, the first virtual object (such as the game character A) may be controlled to turn to face the direction of the game character B.

In operation 1032, the target under-attack prompt control is switched to a wheel control.

In some embodiments, taking an example in which the first virtual object is a game character A controlled by a player 1, and the target under-attack prompt control is an under-attack prompt control 1 corresponding to a game character B controlled by a player 2, when a press operation performed by the player 1 for the under-attack prompt control 1displayed on the left side of the virtual scene is received, the game character A may be controlled to turn to face the direction of the game character B, and the under-attack prompt control 1 may further be switched to a wheel button.

In operation 1033, an aiming control corresponding to a virtual prop to be released by the first virtual object is displayed in the virtual scene.

In some embodiments, following the above example, when the under-attack prompt control 1 is switched to the wheel button, the aiming control (such as a reticle) corresponding to a virtual prop (such as a virtual grappling hook) to be released by the game character A may further be displayed in the virtual scene. That is, when a press operation performed by the player 1 for the under-attack prompt control 1 is received, in addition to controlling the game character A to turn to face the direction of the game character B, the reticle corresponding to the virtual grappling hook to be released by the game character A may further be displayed in the virtual scene. In this way, the player 1 may press the under-attack prompt control to quickly steer the game character and perform aiming of the grappling hook. The operation is more rapid and convenient, which further improves the human-computer interaction efficiency in the virtual scene.

In some embodiments, when the aiming control (such as the reticle) corresponding to the virtual prop to be released by the first virtual object is displayed in the virtual scene, the following processing may further be performed: displaying an unrelease control (such as an “unrelease” button) in the virtual scene; and cancelling, in response to a trigger operation for the unrelease control, display of the wheel control, the aiming control, and the unrelease control in the virtual scene.

For example, taking an example in which the first virtual object is a game character A controlled by a player 1, when the reticle corresponding to the virtual grappling hook to be released by the game character A is displayed in the virtual scene, the unrelease button may further be displayed in the virtual scene, and when a click operation performed by the player 1 for the unrelease button is received, display of the wheel button, the reticle, and the unrelease button may be cancelled in the virtual scene.

In some other embodiments, following the above example, the following processing may further be performed: correspondingly adjusting, in response to the drag operation for the wheel control, a position of the aiming control in the virtual scene according to a drag direction and a drag amplitude of a drag operation; and controlling, in response to the drag operation being released, the first virtual object to release the virtual prop in a direction corresponding to an adjusted aiming control.

For example, taking an example in which the first virtual object is a game character A controlled by a player 1, and the virtual prop is a virtual grappling hook, when a drag operation performed by the player 1 for the wheel button is received, a drag direction and a drag distance corresponding to the drag operation may be acquired, and the position of the reticle corresponding to the virtual grappling hook in the virtual scene is correspondingly adjusted according to the acquired drag direction and drag distance. For example, assuming that the drag direction is leftward and the drag distance is one centimeter, the reticle corresponding to the virtual grappling hook may be controlled to move leftwards by one centimeter in the virtual scene. That is, a movement direction of the reticle corresponding to the virtual grappling hook is consistent with the drag direction of the drag operation. A movement distance of the reticle in the virtual scene may be in positive correlation with the drag distance of the drag operation, i.e., the greater the drag distance, the greater the movement distance of the reticle in the virtual scene. Subsequently, when detecting that the drag operation is released, that is, i.e., release of the player 1, the game character A may be controlled to release the virtual grappling hook in a direction corresponding to the adjusted reticle.

In some embodiments, during the response to the drag operation for the wheel control, the following processing may further be performed: correspondingly adjusting, in response to a slide operation for a blank region of the virtual scene, a viewing angle of the first virtual object in the virtual scene, according to a slide direction and a slide amplitude (such as a slide distance) of the slide operation.

For example, taking an example in which the first virtual object is a game character A controlled by a player 1, when the player 1 drags the wheel button to adjust the reticle corresponding to the virtual grappling hook, the player 1 may further adjust a viewing angle of the game character 1 through a slide operation triggered in the blank region of the virtual scene. For example, when a slide operation triggered by the player 1 for the blank region of the virtual scene is received, a slide direction and a slide distance of the slide operation may be acquired, and a viewing angle of the game character A in the virtual scene is correspondingly adjusted according to the acquired slide direction and slide distance. For example, assuming that the slide direction is leftward and the slide distance is one centimeter, the viewing angle of the game character A may be offset to the left by 5 degrees (for example, the body of the game character A is controlled to offset to the left by 5 degrees). That is, a rotation direction of the viewing angle of the game character A is consistent with the slide direction, and a rotation angle of the viewing angle is positively correlated with the slide distance, i.e., the greater the slide distance, the larger the corresponding rotation angle.

In some embodiments, the virtual prop may be a virtual grappling hook, and the following processing may further be performed: causing damage to the second virtual object in response to the virtual prop hitting the second virtual object corresponding to the target under-attack prompt control, and moving the second virtual object to the position of the first virtual object, or moving the first virtual object to the position of the second virtual object.

For example, taking an example in which the first virtual object is a game character A controlled by a player 1, and the target under-attack prompt control is an under-attack prompt control corresponding to a game character B controlled by a player 2, when the virtual grappling hook emitted by the game character A hits the game character B, the game character B may be damaged, where a damage value may be positively correlated with a distance between the game character A and the game character B, i.e., the greater the distance, the larger the caused damage value. Certainly, the damage value may be positively correlated with the level of the game character A, i.e., the higher the level of the game character A, the larger the damage value caused to the game character B. Meanwhile, an animation that the game character A moves to the position of the game character B through the virtual grappling hook may be presented, or an animation that the game character A hooks the game character B to the position of the game character A through the virtual grappling hook may be presented.

In the virtual scene interaction processing method provided in this embodiment of this application, when a virtual object (i.e., the first virtual object) controlled by a player is attacked by another virtual object (i.e., the second virtual object) in a virtual scene, the under-attack prompt control carrying the attack direction for instructing an attacker (i.e., the second virtual object) is displayed in the virtual scene; and when a trigger operation performed by the player for a selected under-attack prompt control (i.e., the target under-attack prompt control) is received, the first virtual object may be controlled to turn to the direction opposite to the pointing direction of the target under-attack prompt control, i.e., to face a direction of the second virtual object corresponding to the target under-attack prompt control. In this way, compared with the technical solution provided in the related art, the technical solutions provided in the embodiments of this application can quickly and efficiently control the virtual object to turn to the attacker, which facilitates the player to launch a counterattack, thereby effectively improving the human-computer interaction efficiency in the virtual scene. Meanwhile, the game progress can also be effectively accelerated, thereby saving resource overheads of a server and a terminal device.

An exemplary application of an embodiment of this application in an actual application scene is described below by using a massive multiplayer online role-playing game (MMORPG) as an example.

With the development of technologies and the improvement of performance of mobile devices, the human-computer interaction interface is inevitably operated in a more convenient and more efficient control manner, so that the player may have a more pleasant human-computer interaction mode. In view of this, an embodiment of this application provides a virtual scene interaction processing method, which may conveniently implement quick turnaround of the game character, and aiming and release of an enemy without requiring multi-step operations of the player. For example, in a mobile game, if the game character controlled by the player is attacked by a remote enemy (such as a game character controlled by another player), an under-attack prompt may be displayed on a screen, and the player may turn the screen and quickly aim the grappling hook by dragging the under-attack prompt control. In this way, compared with a solution provided in the related art in which a player needs to first turn the screen, then click a grappling hook operation, and finally perform aiming and release, the technical solution provided in the embodiments of this application is more quick and convenient in operation, thereby improving the human-computer interaction efficiency.

The virtual scene interaction processing method provided in the embodiments of this application is described in detail below.

In some embodiments, taking a mobile game as an example, in the mobile game, when a game character (corresponding to the above first virtual object) controlled by a player is attacked by remote emission of a game character (corresponding to the above second virtual object) controlled by another player, an under-attack prompt (corresponding to the above under-attack prompt control) with a direction indication may be displayed on a screen, and may be presented by 360 degrees.

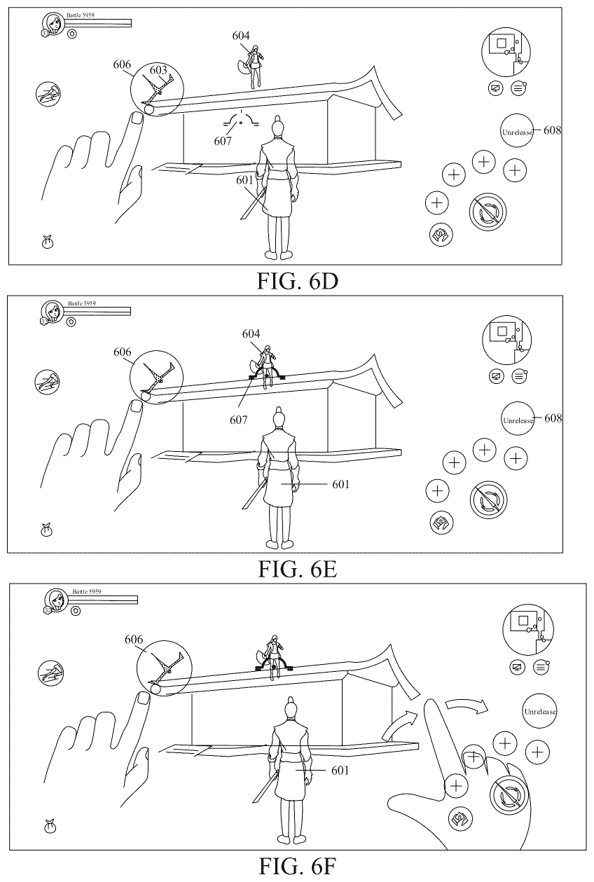

For example, FIG. 6A is a schematic diagram of a second application scene of a virtual scene interaction processing method provided in an embodiment of this application. As shown in FIG. 6A, in the mobile game, when a game character 601 controlled by a player is attacked by remote emission from an enemy (such as a game character controlled by another player), an under-attack prompt 602 with a direction indication may be displayed on a screen.

The purpose of showing a plurality of under-attack prompts from different angles in FIG. 6A is to describe that the prompts may be presented by 360 degrees. During actual application, generally, only one under-attack prompt is displayed on the screen at the same moment. Certainly, when a game character controlled by a player is attacked by a plurality of enemies at the same time, a plurality of under-attack prompts respectively corresponding to a plurality of enemies may also be simultaneously displayed on the screen.

In some embodiments, after the under-attack prompt is received, for example, assuming that the under-attack prompt appears on the left side of the screen, the player may click the under-attack prompt with a left hand, thereby quickly turning to face the direction of the enemy on the left side. Similarly, when the under-attack prompt appears on the right side of the screen, the player may click the under-attack prompt with a right hand, thereby quickly turning to face the direction of the enemy on the right side.

For example, FIG. 6B is a schematic diagram of a third application scene of a virtual scene interaction processing method provided in an embodiment of this application. As shown in FIG. 6B, the under-attack prompt 603 is displayed on the left side of the screen. When a click operation of a player for the under-attack prompt control 603 is received, for example, the player may click the under-attack prompt control 603 with the left hand, a game character 601 may be controlled to quickly turn to face an enemy 604 (such as a game character controlled by another player) located on the left side of the game character 601, so as to launch a counterattack against the enemy 604.

In some embodiments, if the attack comes from the back of the player, a corresponding under-attack prompt may be displayed on the lower part of the screen. After the player clicks the under-attack prompt with a finger, the player may turn around quickly and face the enemy.

For example, FIG. 6C is a schematic diagram of a fourth application scene of a virtual scene interaction processing method provided in an embodiment of this application. As shown in FIG. 6C, when a game character 601 controlled by a player is attacked by a remote emission from the enemy behind, the corresponding under-attack prompt 605 may be displayed on the lower part of the screen. When a click operation performed by the player for the under-attack prompt 605 is received, the game character 601 may be controlled to turn around quickly, so as to face the enemy behind.

In some embodiments, if the player presses the under-attack prompt and generates a drag operation when the under-attack prompt occurs, after a game character (referred to as a player character for short) controlled by the player completes a basic response (i.e., turns to an attacker), the under-attack prompt displayed on the screen is also switched to the wheel button. For example, the wheel button may be displayed by using a center point of the under-attack prompt as the center of a circle. Dragging the wheel button by the player with a finger triggers a grappling hook operation. For example, a reticle of the cable hook and an unrelease button may be displayed on the screen.

For example, FIG. 6D is a schematic diagram of a fifth application scene of a virtual scene interaction processing method provided in an embodiment of this application. As shown in FIG. 6D, the under-attack prompt 603 is displayed on the left side of the screen. When a press operation of a player for the under-attack prompt control 603 is received, while a game character 601 is controlled to quickly turn to face a direction of an enemy 604 located on the left side, the under-attack prompt 603 may further be switched to a wheel button 606. When a drag operation of the player for the wheel button 606 is received, a reticle 607 corresponding to a virtual grappling hook to be emitted by the game character 601, and an unrelease button 608 may be displayed on the screen.

In some embodiments, following the above example, if the player drags the wheel button with a left hand at this time, the player adjusts the grappling hook to perform aiming, and releases the grappling hook after releasing the hand. Certainly, the player may also click an unrelease button with a right hand for cancellation.

For example, FIG. 6E is a schematic diagram of a sixth application scene of a virtual scene interaction processing method provided in an embodiment of this application. As shown in FIG. 6E, when a drag operation of a player for a wheel button 606 is received, a position of a reticle 607 on a screen may be correspondingly adjusted according to a drag direction and a drag distance of the drag operation. That is, the player may perform aiming by dragging the wheel button. When the reticle 607 moves to a position overlapping an enemy 604, the player may release a hand. In this case, a game character 601 may be controlled to emit a virtual grappling hook in a direction corresponding to the adjusted reticle 607, to damage the enemy 604. Certainly, the player may also click the unrelease button 608 for cancellation. For example, when a click operation of the player for the unrelease button 608 is received, display of the wheel button 606, the reticle 607, and the unrelease button 608 may be cancelled on the screen.

In some other embodiments, if the player needs to adjust the viewing angle at this time, the player may operate the viewing angle to turn in the blank region with the right hand, to cooperate with the left and right hands. Similarly, if the under-attack prompt appears on the right side of the screen, the player may perform a similar operation with the right hand, which will not be described herein in this embodiment of this application.

For example, FIG. 6F is a schematic diagram of a seventh application scene of a virtual scene interaction processing method provided in an embodiment of this application. As shown in FIG. 6F, a wheel button 606 is displayed on the left side of a screen. If a player needs to adjust a viewing angle during operation of the wheel button 606 with the left hand, the player may use the right hand to slide in a blank region of the screen. The viewing angle of the game character 601 is correspondingly adjusted according to a slide direction and a slide distance of the slide operation, to cooperate with the left and right hands.

The virtual scene interaction processing method provided in this embodiment of this application is further described below from the technical aspect.

In some embodiments, when a game character controlled by a player is attacked remotely, a direction indication with an attack source, which is briefly referred to as an under-attack prompt, may be displayed on a screen, where the under-attack prompt may be formed by a translucent red circular indication region (briefly referred to as an under-attack indication region) and a plurality of flamed under-attack indication buttons (briefly referred to as indication buttons, and corresponding to the above under-attack prompt controls) attached on a circumference (briefly referred to as an indication circumference) of the circular indication region, where the under-attack indication region represents a 360-degree range of the player character on a horizontal plane of a map, while the angular positions of the indication buttons on the indication circumference represent clockwise angles of the attack source relative to the front direction of the player character on the horizontal plane of the map.

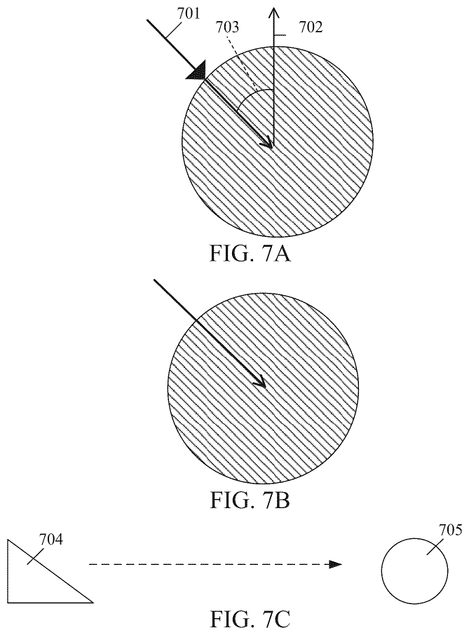

For example, FIG. 7A is a schematic diagram of a second principle of a virtual scene interaction processing method provided in an embodiment of this application. As shown in FIG. 7A, when a player character is hit by a remote bullet attack, an included angle 703 (assumed to be recorded as angleAttacker) between an attack source (i.e., an attacker) and a current orientation of the player character may be calculated according to a flight direction 701 (assumed to be recorded as directionBullet) in which a bullet hits the player character and a direction 702 (assumed to be recorded as directionPlayer) that is right ahead of the player character, i.e., the current orientation of the player character is subtracted from a direction opposite to the bullet flight direction. A specific calculation formula is as follows:

$$angleAttcaker = ( directionBulle {t}^{*} - 1 ) - directionPlayer .$$

In some other embodiments, when a click operation performed by a player for the under-attack prompt button is received, the player character may be controlled to immediately adjust a direction of the player character, to turn to the direction opposite to the bullet flight direction, i.e., face a direction of the attacker.

For example, FIG. 7B is a schematic diagram of a third principle of a virtual scene interaction processing method provided in an embodiment of this application. As shown in FIG. 7B, when an attacker is located at the left front of a player character, and when a click operation performed by the player for an under-attack prompt button is received, the player character may be controlled to face the left front. Similarly, if an attacker is located at the right front of a player character, and when a click operation performed by the player for the under-attack prompt button is received, the player character may be controlled to face the right front; and when the attacker is located behind the player character, and when a click operation performed by the player for the under-attack prompt button is received, the player character may be controlled to turn around, to face the back.

In some embodiments, FIG. 7C is a schematic diagram of a fourth principle of a virtual scene interaction processing method provided in an embodiment of this application. As shown in FIG. 7C, if a player presses the under-attack prompt button 704 without releasing, after a player character completes a basic response (i.e., turns to an attacker), the under-attack prompt button displayed on a screen is switched to a wheel button 705, and this state may be defined as an additional response operation state.

For example, in the additional response operation state, the player may drag the wheel button to control the reticle of a grappling hook skill to start aiming at the attacker. For example, a position of the reticle in the screen may be correspondingly adjusted according to an offset when the player drags the wheel button. An adjustment algorithm is consistent with a shooting aiming reticle following gesture offset algorithms provided in the related art, which is not described in detail herein in this embodiment of this application. In addition, when the player releases the wheel button, the player character may be controlled to release a grappling hook skill.

In some other embodiments, in the additional response operation state, an “unrelease” button may further be displayed above the skill button region on the right side of the screen. When a click operation of the player for the “unrelease” button is received, for example, when the player clicks the “unrelease” button with the right hand, the player may exit from the additional response operation state. In this case, the wheel button, the reticle, and the “unrelease” button all disappear from the screen. In addition, in this embodiment of this application, a requirement for adjusting the viewing angle may also be implemented in a process of the additional response operation. For example, in the process of the additional response operation, if the player has a requirement for adjusting the viewing angle, the player may use the right hand to slide left and right in the blank region of the screen, thereby implementing fine adjustment of the viewing angle.

The technical solution provided in this embodiment of this application is bilaterally symmetrical. The above embodiment describes a case in which the attack is from the left front. If the attack is from the left bottom, the operation modes of the left and right hands of the player are the same. If the attack is from the right front and the right rear of the player character, the operation is symmetrically swapped left and right. That is, the “unrelease” button is displayed on the left side of the screen, meanwhile, a viewing angle adjustment operation may be provided in the blank region on the left side, and a wheel button providing an additional operation is displayed on the right side of the screen.

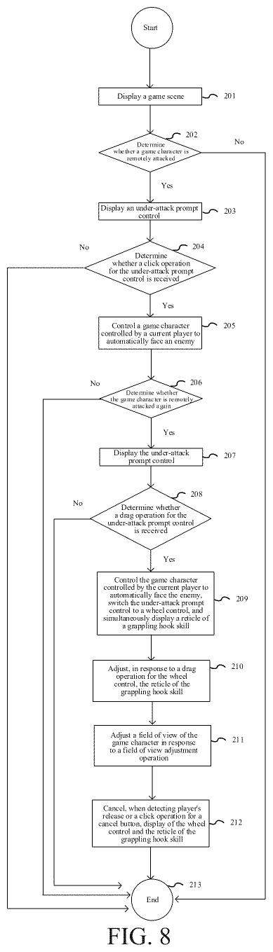

The virtual scene interaction processing method provided in this embodiment of this application is further described below with reference to FIG. 8.

For example, FIG. 8 is the third flowchart of a virtual scene interaction processing method provided in an embodiment of this application, which will be described in combination with operations shown in FIG. 8.

Execution bodies of operation 201 to operation 213 shown in FIG. 8 may be a client running on a terminal device associated with the current player (such as player 1), and the game character controlled by the player 1 (such as a game character A) is attacked by another game character (such as a game character B controlled by player 2) in the game scene.

In operation 201, the game scene is displayed.

In some embodiments, after a game battle is successfully matched, the game scene may be displayed in a human-computer interaction interface of the client, i.e., to enter an in-game battle state.

In operation 202, whether the game character is remotely attacked is determined; if yes, operation 203 is performed; and if not, operation 213 is performed.

In some embodiments, in a running process of a game, whether a game character A controlled by a player 1 is attacked by another game character (such as a game character B controlled by a player 2) in the game may be detected in real time, and if yes, an under-attack prompt control may be displayed near the game character A, where a pointing direction of the under-attack prompt control may be consistent with an attack direction of the game character B.

In operation 203, the under-attack prompt control is displayed.

In operation 204, whether a click operation for the under-attack prompt control is received is determined; if yes, operation 205 is performed; and if not, operation 213 is performed.

In some embodiments, when the click operation of the player 1 for the under-attack prompt control is received, the game character A may be controlled to quickly and automatically to face the game character B (i.e., the attacker).

In operation 205, the game character controlled by the current player is controlled to automatically face the enemy.

In operation 206, whether the game character is remotely attacked again is determined; if yes, operation 207 is performed; and if not, operation 213 is performed.

In some embodiments, whether the game character A is attacked by another game character in the game may be judged again, and if yes, the under-attack prompt control may be displayed again near the game character A.

In operation 207, the under-attack prompt control is displayed.

In operation 208, whether a drag operation for the under-attack prompt control is received is determined; if yes, operation 209 is performed; and if not, operation 213 is performed.

In some embodiments, when the drag operation of the player 1 for the under-attack prompt control is received, the under-attack prompt control may be switched to the wheel control, and a reticle of a grappling hook skill may further be displayed, where the reticle may be configured to represent an emission direction of the grappling hook skill. The player 1 may adjust the reticle of the grappling hook skill by dragging the wheel control. For example, when the reticle of the grappling hook skill coincides with the game character B, the player 1 may control the game character A to use the grappling hook skill, to emit a hook to the game character B.

In operation 209, the game character controlled by the current player is controlled to automatically face the enemy, the under-attack prompt control is switched to a wheel control, and the reticle of the grappling hook skill is simultaneously displayed.

In operation 210, the reticle of the grappling hook skill is adjusted in response to the drag operation for the wheel control.

In some embodiments, the player may drag the wheel button with the left hand, to adjust the reticle of the grappling hook skill.

In operation 211, a field of view of the game character is adjusted in response to the field of view adjustment operation.

In some embodiments, the player 1 may slide left and right in the blank region of the screen with the right hand, to implement fine adjustment of the viewing angle (or referred to as the field of view) of the player character. For example, when detecting that the player 1 slides leftwards in the blank region of the screen, the game character A may be controlled to rotate leftwards, to adjust the field of view of the game character A leftwards.

In operation 212, when detecting player's release or a click operation for a cancel button, display of the wheel control and the reticle of the grappling hook skill is cancelled.

In some embodiments, when detecting the player's release or receiving the click operation of the player for the cancel button, display of the wheel control and the reticle of the grappling hook skill may be cancelled.

In operation 213, the procedure is ended.

In conclusion, the virtual scene interaction processing method provided in the embodiments of this application has the following beneficial effects: the technical solution provided in the embodiments of this application is widely applied to games having operation efficiency to be improved. An operation that originally needs a plurality of operations may be quickly and efficiently completed, thereby significantly improving the operation experience of the player, and further providing more fun of the game for the player.

An exemplary structure of a virtual scene interaction processing apparatus 555 implemented as a software module provided in the embodiments of this application is further described below. In some embodiments, as shown in FIG. 2, the software module of the virtual scene interaction processing apparatus 555 stored in a memory 550 may include: a display module 5551 and a control module 5552.

The display module 5551 is configured to display a virtual scene in a human-computer interaction interface, where the virtual scene includes a plurality of virtual objects; the display module 5551 is further configured to display, in response to the first virtual object being attacked by at least one second virtual object, at least one under-attack prompt control in the virtual scene, where a pointing direction of each under-attack prompt control is consistent with an attack direction of the corresponding second virtual object; and the control module 5552 is configured to control, in response to a trigger operation for a target under-attack prompt control, the first virtual object to turn to a target direction, where the target under-attack prompt control is a selected under-attack prompt control among the at least one under-attack prompt control, and the target direction is the direction opposite to the pointing direction of the target under-attack prompt control.

In some embodiments, the display module 5551 is further configured to display in the human-computer interaction interface an under-attack prompt region centered on the first virtual object; the virtual scene interaction processing apparatus 555 further includes a determination module 5553 configured to, for each second virtual object, determine an included angle between the direction opposite to the attack direction of the second virtual object and a current orientation of the first virtual object; and determine a position corresponding to the included angle in the under-attack prompt region; the display module 5551 is further configured to display in the position the under-attack prompt control corresponding to the second virtual object.

In some embodiments, the determination module 5553 is further configured to, starting, in a plane in which the human-computer interaction interface is located, from the first virtual object, emit a detection ray in a direction that is offset counterclockwise from a reference direction by the included angle, where the reference direction is a direction corresponding to the current orientation of the first virtual object in the plane; and determine an intersection point of the detection ray and an edge of the under-attack prompt region as the position corresponding to the included angle in the under-attack prompt region.

In some embodiments, the display module 5551 is further configured to perform the following processing for each second virtual object: acquiring a distance between the second virtual object and the first virtual object in the virtual scene; determining a size matching the distance, where the size is negatively correlated with the distance; and displaying in the virtual scene the under-attack prompt control corresponding to the second virtual object and conforming to the size.

In some embodiments, the display module 5551 is further configured to perform the following processing for each second virtual object: acquiring, in response to the second virtual object attacking the first virtual object, a damage value caused by the second virtual object to the first virtual object; determining a size matching the damage value, where the size is positively correlated with the damage value; and displaying in the virtual scene the under-attack prompt control corresponding to the second virtual object and conforming to the size.

In some embodiments, when the number of at least one second virtual object is multiple, the virtual scene interaction processing apparatus 555 further includes an acquisition module 5554 configured to acquire, in response to a plurality of second virtual objects attacking the first virtual object, damage values caused by the second virtual objects to the first virtual object, respectively; and a display module 5551 further configured to display in the virtual scene the under-attack prompt control corresponding to a target second virtual object, where the target second virtual object is the second virtual object that causes a maximum damage value to the first virtual object among the plurality of second virtual objects.

In some embodiments, when the number of at least one second virtual object is multiple, the acquisition module 5554 is further configured to acquire distances between the first virtual object and a plurality of second virtual objects in the virtual scene, respectively; the determination module 5553 is further configured to determine, according to the distances, a target second virtual object located within an attack range of the first virtual object among the plurality of second virtual objects; and the display module 5551 is further configured to display in the virtual scene an under-attack prompt control corresponding to the target second virtual object.

In some embodiments, when the number of at least one second virtual object is multiple, the virtual scene interaction processing apparatus 555 further includes a prediction module 5555 configured to, based on feature information corresponding to the plurality of second virtual objects, call the first machine learning model for prediction to obtain hazard parameters of the second virtual objects for the first virtual object, where the feature information includes at least one of the following: distances from the first virtual object, skills of the second virtual objects, and virtual props held by the second virtual objects; and a display module 5551 further configured to display in the virtual scene an under-attack prompt control corresponding to the target second virtual object, where the target second virtual object is a second virtual object with a hazard parameter greater than a hazard parameter threshold.

In some embodiments, the virtual scene interaction processing apparatus 555 further includes a training module 5556 configured to perform the following processing before the prediction module 5555 calls the first machine learning model for prediction: acquiring a sample first virtual object and a plurality of sample second virtual objects, where each of the sample second virtual objects is labeled with a hazard parameter for the sample first virtual object; based on feature information corresponding to the plurality of sample second virtual objects, calling the initialized first machine learning model for prediction to obtain hazard parameters of the sample second virtual objects for the sample first virtual object; determining errors between the predicted hazard parameters and the pre-labeled hazard parameters; and performing backpropagation based on the errors, and updating the parameters of the first machine learning model during the backpropagation process.

In some embodiments, the control module 5552 is further configured to control, in response to the press operation for the target under-attack prompt control, the first virtual object to turn to the target direction; and the display module 5551 is further configured to switch the target under-attack prompt control to a wheel control, and display in the virtual scene an aiming control corresponding to a virtual prop to be released by the first virtual object.

In some embodiments, the virtual scene interaction processing apparatus 555 further includes an adjustment module 5557 configured to correspondingly adjust, in response to the drag operation for the wheel control, a position of the aiming control in the virtual scene according to a drag direction and a drag amplitude of a drag operation; and the control module 5552 is further configured to control, in response to the drag operation being released, the first virtual object to release the virtual prop in a direction corresponding to an adjusted aiming control.

In some embodiments, the control module 5552 is further configured to cause, in response to the virtual prop hitting the second virtual object corresponding to the target under-attack prompt control, damage to the second virtual object, and move the second virtual object to a position of the first virtual object, or move the first virtual object to a position of the second virtual object.

In some embodiments, the adjustment module 5557 is further configured to correspondingly adjust, in response to a slide operation for a blank region of the virtual scene, a viewing angle of the first virtual object in the virtual scene according to a slide direction and a slide amplitude of the slide operation.

In some embodiments, the display module 5551 is further configured to display an unrelease control in the virtual scene; and cancel, in response to a trigger operation for the unrelease control, display of the wheel control, the aiming control, and the unrelease control in the virtual scene.

In some embodiments, the determination module 5553 is further configured to take, in response to a selection operation for the at least one under-attack prompt control, the selected under-attack prompt control as the target under-attack prompt control before the control module 5552 responds to the trigger operation for the target under-attack prompt control; and the display module 5551 is further configured to switch a display mode of the target under-attack prompt control to a highlight mode different from other under-attack prompt controls, where the other under-attack prompt controls are under-attack prompt controls except the target under-attack prompt control.

In some embodiments, the prediction module 5555 is further configured to, based on feature information corresponding to the at least one under-attack prompt control, call the second machine learning model for prediction to obtain selection probabilities corresponding to the under-attack prompt controls, before the control module 5552 responds to a trigger operation for a target under-attack prompt control, where the feature information includes at least one of the following: a distance between the second virtual object corresponding to the under-attack prompt control and the first virtual object, skills of the second virtual object corresponding to the under-attack prompt control, and virtual props held by the second virtual object corresponding to the under-attack prompt control; the determination module 5553 is further configured to take the under-attack prompt control corresponding to the maximum selection probability as the target under-attack prompt control; and the display module 5551 is further configured to switch a display mode of the target under-attack prompt control to a highlight mode different from other under-attack prompt controls, where the other under-attack prompt controls are under-attack prompt controls except the target under-attack prompt control.

The description of the apparatus in this embodiment of this application is similar to the description of the above method embodiments, has beneficial effects similar to those of the method embodiments and thus is not repeatedly described. Technical details not covered in the virtual scene interaction processing apparatus provided in the embodiments of this application may be understood according to the description in any one of FIG. 3 or FIG. 5.

An embodiment of this application provides a computer program product including a computer program or computer-executable instructions, the computer program or the computer-executable instructions being stored in a non-transitory computer-readable storage medium. A processor of a computer device reads the computer-executable instructions from the computer-readable storage medium and executes the computer-executable instructions, to cause the computer device to perform the virtual scene interaction processing method in the embodiments of this application.

An embodiment of this application provides a non-transitory computer-readable storage medium, having computer-executable instructions stored therein, where the computer-readable storage medium stores the computer-executable instructions, and when executed by a processor, the computer-executable instructions causes the processor to perform the virtual scene interaction processing method, such as the virtual scene interaction processing method shown in FIG. 3 or FIG. 5, provided in this embodiment of this application.

In some embodiments, the computer-readable storage medium may be a memory such as a ferroelectric RAM (FRAM), the ROM, a programmable ROM (PROM), an electrically programmable ROM (EPROM), an electrically erasable programmable ROM (EEPROM), a flash memory, a magnetic surface memory, an optical disk, or a CD-ROM, or may be any device including one of or any combination of the above memories.

In some embodiments, the executable instructions may be written in a form of a program, software, a software module, a script, or codes and according to a programming language (including a compiled or interpreted language, or a declarative or procedural language) in any form, and may be deployed in any form, including being deployed as an independent program or being deployed as a module, an assembly, a subroutine, or other units suitable for use in a computing environment.

In an example, the executable instructions may be deployed to be executed on an electronic device, or executed on a plurality of electronic devices at the same location, or executed on a plurality of electronic devices distributed in a plurality of locations and interconnected by a communication network.

The above only describes the embodiments of this application and is not intended to limit a protection scope of this application. Any modification, equivalent replacement, improvement, etc. made within the spirit and the scope of this application are to be included within the protection scope of this application.

What is claimed is:

1. A virtual scene interaction processing method performed by an electronic device, the method comprising:
displaying a virtual scene in a human-computer interaction interface, the virtual scene comprising a plurality of virtual objects;
in response to a first virtual object being attacked by at least one second virtual object, displaying at least one under-attack prompt control in the virtual scene, a pointing direction of each under-attack prompt control being consistent with an attack direction of a corresponding second virtual object; and
in response to a trigger operation for a target under-attack prompt control, controlling the first virtual object to turn to a target direction, and the target direction being a direction opposite to a pointing direction of the target under-attack prompt control.

2. The method according to claim 1, wherein the displaying in the virtual scene at least one under-attack prompt control comprises:
displaying in the human-computer interaction interface an under-attack prompt region centered on the first virtual object;
determining, for each second virtual object, an included angle between a direction opposite to the attack direction of the second virtual object and a current orientation of the first virtual object; and
determining a position corresponding to the included angle in the under-attack prompt region, and displaying in the position the under-attack prompt control corresponding to the second virtual object.

3. The method according to claim 2, wherein the determining a position corresponding to the included angle in the under-attack prompt region comprises:
starting, in a plane in which the human-computer interaction interface is located, from the first virtual object, emitting a detection ray in a direction that is offset counterclockwise from a reference direction by the included angle, the reference direction being a direction corresponding to the current orientation of the first virtual object in the plane; and
determining an intersection point of the detection ray and an edge of the under-attack prompt region as the position corresponding to the included angle in the under-attack prompt region.

4. The method according to claim 1, wherein the displaying at least one under-attack prompt control in the virtual scene comprises:
performing, for each second virtual object, the following processing:
acquiring a distance between the second virtual object and the first virtual object in the virtual scene;
determining a size matching the distance, the size being negatively correlated with the distance; and
displaying in the virtual scene the under-attack prompt control corresponding to the second virtual object and conforming to the size.

5. The method according to claim 1, wherein the displaying at least one under-attack prompt control in the virtual scene comprises:
performing, for each second virtual object, the following processing:
acquiring, in response to the second virtual object attacking the first virtual object, a damage value caused by the second virtual object to the first virtual object;
determining a size matching the damage value, the size being positively correlated with the damage value; and
displaying in the virtual scene the under-attack prompt control corresponding to the second virtual object and conforming to the size.

6. The method according to claim 1, wherein the displaying in the virtual scene at least one under-attack prompt control comprises:
acquiring, in response to a plurality of second virtual objects attacking the first virtual object, damage values caused by the second virtual objects to the first virtual object, respectively; and
displaying in the virtual scene an under-attack prompt control corresponding to a target second virtual object, the target second virtual object being a second virtual object that causes a maximum damage value to the first virtual object among the plurality of second virtual objects.

7. The method according to claim 1, wherein the displaying at least one under-attack prompt control in the virtual scene comprises:
acquiring distances between the first virtual object and a plurality of second virtual objects in the virtual scene, respectively;
determining, according to the distances, a target second virtual object located within an attack range of the first virtual object among the plurality of second virtual objects; and
displaying in the virtual scene an under-attack prompt control corresponding to the target second virtual object.

8. The method according to claim 1, wherein the displaying at least one under-attack prompt control in the virtual scene comprises:
calling, based on feature information corresponding to a plurality of second virtual objects, a first machine learning model for prediction to obtain hazard parameters of the second virtual objects for the first virtual object, the feature information comprising at least one of the following: distances from the first virtual object, skills of the second virtual objects, and virtual props held by the second virtual objects; and
displaying in the virtual scene an under-attack prompt control corresponding to a target second virtual object, the target second virtual object being a second virtual object with a hazard parameter greater than a hazard parameter threshold.

9. The method according to claim 1, wherein the controlling the first virtual object to turn to a target direction comprises:
in response to a press operation for the target under-attack prompt control, controlling the first virtual object to turn to the target direction, and switching the target under-attack prompt control to a wheel control, and
displaying in the virtual scene an aiming control corresponding to a virtual prop to be released by the first virtual object.

10. The method according to claim 1, wherein before the response to a trigger operation for a target under-attack prompt control, the method further comprises:
in response to a selection operation for the at least one under-attack prompt control, taking the selected under-attack prompt control as the target under-attack prompt control, and switching a display mode of the target under-attack prompt control to a highlight mode different from display modes of other under-attack prompt controls, the other under-attack prompt controls being under-attack prompt controls except the target under-attack prompt control.

11. The method according to claim 1, wherein before the response to a trigger operation for a target under-attack prompt control, the method further comprises:
based on feature information corresponding to the at least one under-attack prompt control, invoking a second machine learning model for prediction to obtain selection probabilities corresponding to the under-attack prompt controls, the feature information comprising at least one of the following: a distance between a second virtual object corresponding to the under-attack prompt control and the first virtual object, skills of the second virtual object corresponding to the under-attack prompt control, and virtual props held by the second virtual object corresponding to the under-attack prompt control; and
taking an under-attack prompt control corresponding to a maximum selection probability as the target under-attack prompt control, and switching a display mode of the target under-attack prompt control to a highlight mode different from display modes of other under-attack prompt controls, the other under-attack prompt controls being under-attack prompt controls except the target under-attack prompt control.

12. An electronic device, comprising:
a memory, configured to store executable instructions; and
a processor, configured to, when executing the executable instructions stored in the memory, causing the electronic device to implement a virtual scene interaction processing method including:
displaying a virtual scene in a human-computer interaction interface, the virtual scene comprising a plurality of virtual objects;
in response to a first virtual object being attacked by at least one second virtual object, displaying at least one under-attack prompt control in the virtual scene, a pointing direction of each under-attack prompt control being consistent with an attack direction of a corresponding second virtual object; and
in response to a trigger operation for a target under-attack prompt control, controlling the first virtual object to turn to a target direction, and the target direction being a direction opposite to a pointing direction of the target under-attack prompt control.

13. The electronic device according to claim 12, wherein the displaying in the virtual scene at least one under-attack prompt control comprises:
displaying in the human-computer interaction interface an under-attack prompt region centered on the first virtual object;
determining, for each second virtual object, an included angle between a direction opposite to the attack direction of the second virtual object and a current orientation of the first virtual object; and
determining a position corresponding to the included angle in the under-attack prompt region, and displaying in the position the under-attack prompt control corresponding to the second virtual object.

14. The electronic device according to claim 12, wherein the displaying at least one under-attack prompt control in the virtual scene comprises:
performing, for each second virtual object, the following processing:
acquiring a distance between the second virtual object and the first virtual object in the virtual scene;
determining a size matching the distance, the size being negatively correlated with the distance; and
displaying in the virtual scene the under-attack prompt control corresponding to the second virtual object and conforming to the size.

15. The electronic device according to claim 12, wherein the displaying at least one under-attack prompt control in the virtual scene comprises:
performing, for each second virtual object, the following processing:
acquiring, in response to the second virtual object attacking the first virtual object, a damage value caused by the second virtual object to the first virtual object;
determining a size matching the damage value, the size being positively correlated with the damage value; and
displaying in the virtual scene the under-attack prompt control corresponding to the second virtual object and conforming to the size.

16. The electronic device according to claim 12, wherein the displaying in the virtual scene at least one under-attack prompt control comprises:
acquiring, in response to a plurality of second virtual objects attacking the first virtual object, damage values caused by the second virtual objects to the first virtual object, respectively; and
displaying in the virtual scene an under-attack prompt control corresponding to a target second virtual object, the target second virtual object being a second virtual object that causes a maximum damage value to the first virtual object among the plurality of second virtual objects.

17. The electronic device according to claim 12, wherein the displaying at least one under-attack prompt control in the virtual scene comprises:
acquiring distances between the first virtual object and a plurality of second virtual objects in the virtual scene, respectively;
determining, according to the distances, a target second virtual object located within an attack range of the first virtual object among the plurality of second virtual objects; and
displaying in the virtual scene an under-attack prompt control corresponding to the target second virtual object.

18. The electronic device according to claim 12, wherein the displaying at least one under-attack prompt control in the virtual scene comprises:
calling, based on feature information corresponding to a plurality of second virtual objects, a first machine learning model for prediction to obtain hazard parameters of the second virtual objects for the first virtual object, the feature information comprising at least one of the following: distances from the first virtual object, skills of the second virtual objects, and virtual props held by the second virtual objects; and
displaying in the virtual scene an under-attack prompt control corresponding to a target second virtual object, the target second virtual object being a second virtual object with a hazard parameter greater than a hazard parameter threshold.

19. The electronic device according to claim 12, wherein the controlling the first virtual object to turn to a target direction comprises:
in response to a press operation for the target under-attack prompt control, controlling the first virtual object to turn to the target direction, and switching the target under-attack prompt control to a wheel control, and
displaying in the virtual scene an aiming control corresponding to a virtual prop to be released by the first virtual object.

20. A non-transitory computer-readable storage medium, having computer-executable instructions stored therein, the computer-executable instructions, when executed by a processor of an electronic device, causing the electronic device to implement a virtual scene interaction processing method including:
displaying a virtual scene in a human-computer interaction interface, the virtual scene comprising a plurality of virtual objects;
in response to a first virtual object being attacked by at least one second virtual object, displaying at least one under-attack prompt control in the virtual scene, a pointing direction of each under-attack prompt control being consistent with an attack direction of a corresponding second virtual object; and
in response to a trigger operation for a target under-attack prompt control, controlling the first virtual object to turn to a target direction, and the target direction being a direction opposite to a pointing direction of the target under-attack prompt control.
